(19) United States
(12) Patent Application Publication
(10) Pub. No.: US 2010/0198860 A1
(43) Pub. Date: Aug. 5, 2010

(54) METHOD AND SYSTEM FOR CONTENT DELIVERY

(75) Inventors: Ian Shaw Burnett, Victoria (AU); Stephen James Davis, New South Wales (AU); Gerrard Matthew Drury, New South Wales (AU)

Correspondence Address: MERCHANT & GOULD PC, P.O. BOX 2903, MINNEAPOLIS, MN, 55402-0903, US

(73) Assignee: Enikos Pty Limited, Eveleigh, New South Wales (AU)

(21) Appl. No.: 12/529,655

(22) PCT Filed: Mar. 3, 2008
(86) PCT No.: PCT/AU08/00302

§ 371 Date: Mar. 11, 2010

Related U.S. Application Data
(60) Provisional application No. 60/892,589, filed on Mar. 2, 2007.

(51) Int. Cl. G06F 3/01; G06F 15/16; G06F 17/30; G06F 17/00

(52) U.S. Cl. 707/769; 715/730; 709/217; 715/234; 707/E17.014

(57) ABSTRACT

The present invention provides a system and method for providing a presentation to a user. The system comprises a framework arranged to provide a time based primary media element and at least one secondary media element to the user, wherein the at least one secondary media element is arranged to be presented to the user when a predetermined time is reached during presentation of the primary media element.

### FIELD OF THE INVENTION

The present invention generally relates to a system and method for managing and displaying multimedia content.

The system and method described herein finds particular, but not exclusive, use in conjunction with a graphical user interface which is the subject of a co-pending provisional patent application entitled a “A Graphical User Interface” filed in the name of Ian Shaw Burnett, Stephen James Davis and Gerrard Mathew Drury and assigned to Enikos Pty Ltd (an Australian company) before the United States Patent and Trade Mark Office on 2 Mar. 2007, which is incorporated herein by reference.

### BACKGROUND OF THE INVENTION

The Internet provides consumers with access to an unprecedented amount of information of many types, including static text, video, still images, audio and combinations thereof.

The most well known and widely recognised method and system for presenting publicly accessible content on the Internet is the webpage. HTML (hyper text mark-up language) is able to display any text and embed many different types of multimedia content, including video, still images and audio, into a single ‘page’.

However, an HTML page remains a substantially static (as opposed to dynamic) experience. While a user may access further information by following a link, HTML is not equipped to allow a user to easily update content, or to receive updated content.

### SUMMARY OF THE INVENTION

In a first aspect, the present invention provides a system for providing a presentation to a user comprising a framework arranged to provide a time based primary media element and at least one secondary media element to a user, wherein the at least one secondary media element is arranged to be presented to the user when a predetermined time is reached during presentation of the primary media element.

The framework may include a retrieval module arranged to retrieve the primary media element and the at least one secondary media element, and temporarily associate the primary media element and the at least one secondary media element.

There may be provided a client application arranged to display the primary media element and the at least one secondary media element in a unified interface. The client application may include the retrieval module.

There may be further included a database arranged to hold information regarding the primary media element and the at least one secondary media element.

The retrieval module may include a timing module arranged to poll the database at predetermined time intervals, to determine whether further secondary media elements should be retrieved.

The framework information may include information regarding the location of the primary media element and the at least one secondary media element and also may include timing information.

The database may include a locator arranged to allow the retrieval module to locate each one of the primary media element and the at least one secondary media element. The timing information and the locator may be linked.

The timing module may receive the timing information to determine whether a further at least one secondary media element should be displayed, and if so, utilises the linked locator information to retrieve the element.

The timing module may receive a plurality of discrete timing information sets, each timing information set operating independently of each other timing information set.

The locator may direct the client application to a third party server containing one of the primary media element and the at least one secondary media element.

The database may be located remotely from the client application.

The client application may be a web browser, capable of interpreting HyperText Markup Language (HTML) and the JavaScript scripting language.

The web browser may include a widget arranged to connect with the servlet application to receive the locator information

The primary and secondary media elements may be any type of file or information, including an audio file, a video file, a text file, a file constructed from information extracted from other files (i.e. a file constructed ‘on the fly’) or any other type of information.

The database may contain information in an XML format, and more particularly, the XML format may be compatible with an MPEG standard.

In a second aspect, the present invention provides a method for providing a presentation to a user comprising the steps of providing a time based primary media element and at least one secondary media element to a user, whereby the at least one secondary media element is arranged to be presented to the user when a predetermined time is reached during presentation of the primary media element.

In a third aspect, the present invention provides a computer program arranged to, when executed on a computing system, perform the steps in accordance with a second aspect of the invention.

In a fourth aspect, the present invention provides a computer readable medium incorporating a computer program in accordance with a third aspect of the invention.

### DETAILED DESCRIPTION OF THE DRAWINGS

Notwithstanding any other forms which may fall within the scope of the present invention, a preferred embodiment will now be described, by way of example only, with reference to the accompanying drawings in which:

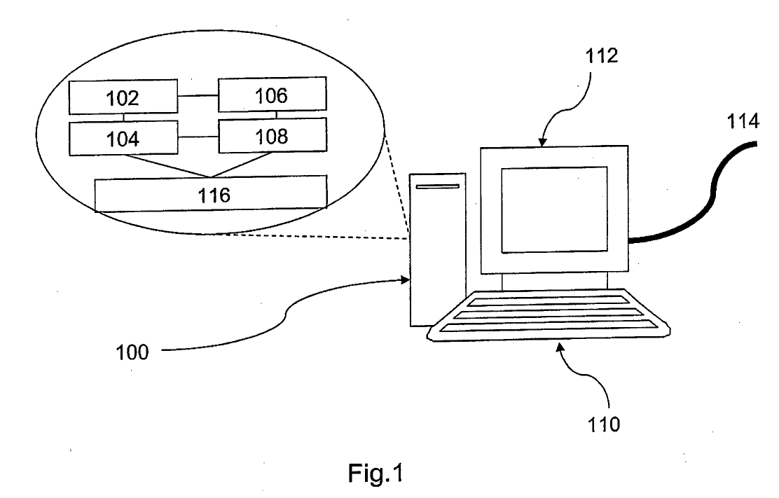

FIG. 1 is a diagram illustrating a computing system suitable for implementing a methodology or system in accordance with an embodiment of the present invention;

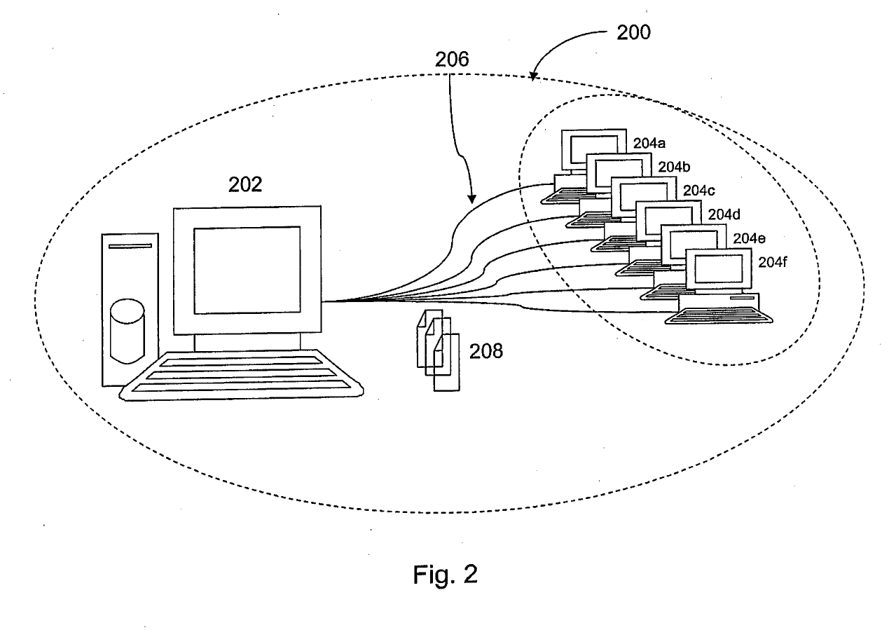

FIG. 2 is a diagram illustrating a computer network suitable for implementing a methodology or system in accordance with an embodiment of the present invention;

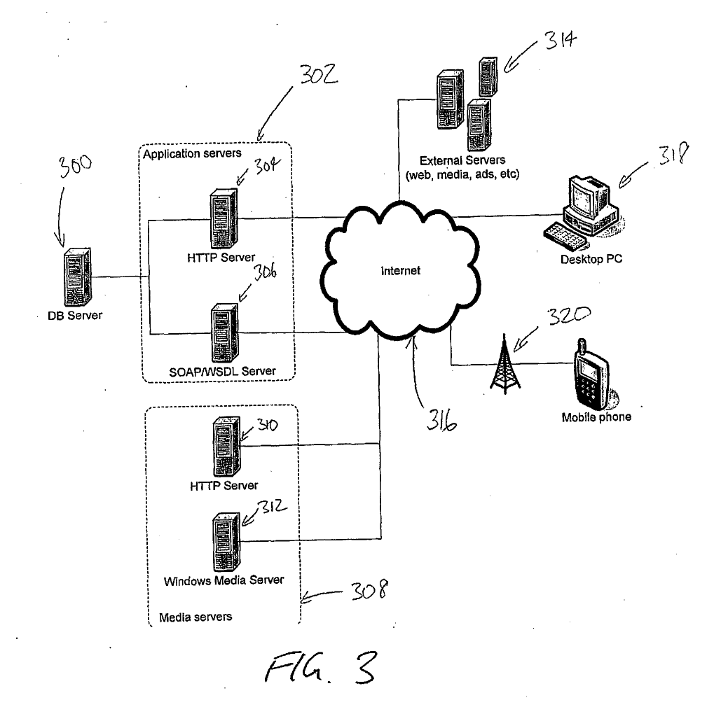

FIG. 3 is a system in accordance with an embodiment of the present invention; and

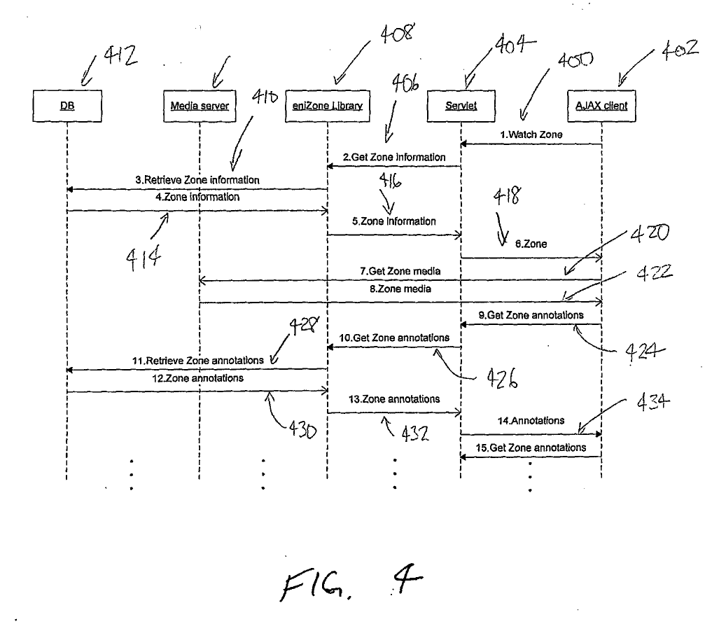

FIG. 4 is a diagram illustrating the method steps performed by a system in accordance with an embodiment of the present invention.

### DESCRIPTION OF SPECIFIC EMBODIMENTS

### Overview

The system and methodology (and associated software application) in accordance with an embodiment of the invention may be executed on a computing system such as the example computing system shown in FIG. 1. At FIG. 1 there is shown a schematic diagram of a computing system 100 suitable for use with an embodiment of the present invention. The computing system 100 may be used to execute applications and/or system services such as deployment services in accordance with an embodiment of the present invention.

The computing system 100 preferably comprises a processor 102, read only memory (ROM) 104, random access memory (RAM) 106, and input/output devices such as disk drives 108, keyboard 110 (or other input peripherals such as a mouse, not shown), display 112 (or other output peripherals such as a printer, not shown) and communications link 114. The computer includes programs that may be stored in ROM 104, RAM 106, or disk drives 108 and may be executed by the processor 102. The communications link 114 connects to a computer network but could be connected to a telephone line, an antenna, a gateway or any other type of communications link. Disk drives 108 may include any suitable storage media, such as, for example, floppy disk drives, hard disk drives, CD ROM drives or magnetic tape drives. The computing system 100 may use a single disk drive or multiple disk drives. The computing system 100 may use any suitable operating system, such as Microsoft Windows™ or, Apple Mac OS-X™ or Unix™. The computing system 100 may be a server arranged to send information to one or more client computers. The computing system 100 may be capable of executing a software application 116 (which may be in the form of an API) in accordance with an embodiment of the invention.

It will be understood that the computing system described in the preceding paragraphs is illustrative only and that the presently described embodiment or other embodiments which fall within the scope of the claims of the present application may be executed on any suitable computing system, which in turn may be realized utilizing any suitable hardware and/or software. Other computing systems that may be suitable include server computers, hand-held or portable computing devices, consumer electronics, and other devices capable of receiving electronic information, including automated ‘teller’ machines and vending machines.

FIG. 2 illustrates an example network environment 200, with a server computer 202 in communication with client computers 204a, 204b, 204c, etc., via a network (or a bus) 206, in which an embodiment of the present invention may be employed. In more detail, the server 202 may be a server including a database arranged to provide information to a number of client machines 204a, 204b, 204c, etc., via the communications network 206, which may be a local or wide area network, such as an intranet, the Internet, etc. It will be understood that the client computers need not be client machines, but may be a terminal, another computing system, a portable communications device, such as a mobile telephone, or any other device capable of receiving information from the server.

The server 202, and the client devices 204a, 204b, 204c, etc., may communicate with each other over the communications network 206 by use of any suitable networking protocol, such as TCP/IP or any other suitable protocol for the exchange of information 208. The exchange of information may include the provision of XML files, the XML files providing information to be utilized and rendered by any or all of the servers and client devices. The XML files may conform with one or more of the MPEG group of standards.

The embodiment described provides a method, system and software application for temporarily associating disparate content in a manner which allows the disparate content to be displayed in a logical and coordinated manner.

The system, hereinafter referred to as “eniZone”, allows media from diverse sources to be temporarily and temporally associated. The system provides a flexible framework such that content may be aggregated and deployed in a variety of environments.

A primary media type, which is generally a video or audio file (but could be any suitable temporal media), is displayed in a conventional web browser, which in turn may utilise any available ‘plug-in’ or other application or program to display the primary media type. For example, the ‘plug-in’ may be Realplayer™, Microsoft Media Player™ or a Java application arranged to display temporal media.

Additional media content (which may be any type of content, such as text, a webpage, a file, another video, an audio file, etc.) are associated with the primary media, so that on playback of the primary media, the additional content may be shown in conjunction with the primary media.

The additional content is also displayed in the web browser, or adjacent to the web browser (i.e. in the same screen as the primary media). The additional content is arranged to display during a particular time sub interval of the primary media, so that the sequence in which the additional content is presented to the end user is controlled.

In order to access the media and the additional content, a user accesses an interactive webpage, such as a webpage which utilises AJAX (Asynchronous JavaScript and XML). AJAX is a web development technique for creating interactive web applications.

The AJAX enabled webpage accesses the media by firstly accessing an intermediary server known as an “eniZone” server. The eniZone server contains information regarding the location of the relevant media, and also further temporal information which determines the time and order in which the additional media is displayed. In more detail, the web browser includes, in the URL, a call (request) which connects to a servlet (i.e. a Java application residing on a web server, which receives a request from JavaScript embedded in a webpage, processes the request, and returns a response). The servlet then responds with XML which contains the required information to construct the webpage and access the requisite primary and additional media elements.

One embodiment utilises a standard desktop web browser. A user accesses an eniZone website in the conventional manner, or may access a website which contains an eniZone widget, which is web standard code that is embedded in another website, such as MySpace.

Of course, it will be understood that the embodiment described herein may be utilised to deliver content to other computing devices, such as mobile phones, television set top boxes, etc.

eniZone System Overview

FIG. 3 is a schematic drawing illustrating a system in accordance with one embodiment of the present invention.

The system includes a database server 300 which hosts the database containing the eniZone system information. The information may be divided into sets, the sets including user information, group information, category information, tag information, advertising information and Zone information. Each of the sets of information forms the basis for what is dubbed, in the embodiment described herein, a ‘Zone’. A Zone is a collection of content, the content including a primary media element (such as a video or an audio file) and a plurality of additional media elements (such as webpages, images, text, or other media) which is associated temporarily and temporally with the primary media element.

In more detail, each set of information which defines a Zone may include, but is not limited to, the following sub-sets of information:

User information
User details—e.g. name, email, etc.
User preferences.
User history and statistics.

Group information
Group details.
Group statistics.
Membership information.

Category information—subject categories

Tag information—descriptive metadata tags

Zone information
Identifiers for associated information
   owning user,
   group, if any,
   category id,
   tag(s), if any,
Summary information—e.g. title, description, thumbnail.
Media information—e.g. location, type.
Statistics—e.g. number of views, vote average.

Zone annotations—information and media temporally associated with the Zone that are displayed additionally to the primary media of the Zone. Such additional information can be from a variety of sources and of a variety of types.

Zone overlays—“hot spot” areas overlaid on the Zone video. The overlays are separate from the video media in that the video media is left unchanged, thus enabling overlays to be used with any supported video from any source.

Zone customized layout—optional customized layout for a Zone.

Advertising information—optional information for delivering advertisements associated with a Zone. Advertisements may be targeted based on Zone information, User information, etc. Advertisements may be associated with a particular time sub interval of the primary media, or may be continually present as part of a Zone.

The system utilizes standard database interface APIs (Application Programming Interface), allowing any database to be used for the data store.

The eniZone server library interfacing to the database is developed in Java and the standard database interface API is JDBC (Java Database Connectivity).

In the embodiment described herein, the eniZone server library currently supports MySQL and Oracle databases. However, it will be understood that the system may be readily utilised with any database.

The system also includes one or more application servers (302) which provide an interface between the database server 300 and the end user. FIG. 3 depicts two example application servers which are utilised with the embodiment described herein.

HTTP server 304—hosts a HTTP web server for web access to the eniZone system by clients using any standard web browser.

SOAP/WSDL server 306—hosts a SOAP/WSDL (Web Services Description Language) web services server for access to the system via a web services interface. This can be used, for example, by an application running on a suitably equipped mobile phone.

Other application servers can be added to the system as required for providing access to the eniZone system from other client platforms.

The client side interface of each application server will be specific to the client platform(s) the application server is intended to serve. However, each application server utilizes a common eniZone server library for providing the functionality accessed via the application server.

The system also includes one or more media servers 308 to host and serve media content that is uploaded to the eniZone system.

FIG. 3 depicts two example media servers, namely:

HTTP server 310—hosts (non-streamed) media uploaded to the eniZone system and served via HTTP.

Windows Media server 312—hosts streaming Microsoft Windows Media content uploaded to the eniZone system and served via Windows Media Services.

It will be understood that specialized media servers may be added to the system for handling specific media types, and the system is arranged to receive a large number of different media types, including images, video, audio, and any other type of suitable media.

In addition to servers which make up part of the system, the system may also access third party (external) servers 314 to utilise content hosted on the third party servers. That is, the media does not need to reside on media servers within the eniZone system but can be sourced from any location for which a URL for the media exists. For example, the media could be sourced from other client systems in a peer-to-peer arrangement. Such media can include video, audio, images, text, web content, etc.

Third party servers 314 are also utilized by the eniZone system for supplementary information such as advertising material.

The servers (300-314) will generally be connected together through a suitable network, such as the one described with reference to FIG. 2. In the embodiment described herein, the network is the Internet 316, which is arranged to deliver information to personal computers 318 although it will be understood that the system may also deliver information to other telecommunications networks, such as a mobile telephone network 320 so that a mobile device user may access the system through a mobile device 322.

While FIG. 3 describes one particular embodiment of the invention, it will be understood, however, that the system can be deployed with any one of a number of configurations, including but not limited to:

two or more server processes running on the same physical machine;

a logical server (e.g. the web server) running as multiple processes on multiple physical machines (e.g. for load balancing);

one or more server processes running on a virtualised machine(s);

a single server process serving multiple purposes; and/or

geographically distributed physical machines.

eniZone Server Library

Referring to FIG. 4, there is shown a message flow diagram which depicts the method steps carried out by the system components of FIG. 3, when a request is made to the eniZone server library.

Each application server (depicted in FIG. 3 generally by numeral 302) includes an eniZone application server. A client (i.e. a user, through a browser or other suitable software) makes a request 400 via a client-side interface 402 (i.e. a user interface located in a browser, or more specifically, in the embodiment described herein, an AJAX (Asynchronous JavaScript and XML) client operating within a browser)) of an application server 404 and the application server then calls 406 upon the eniZone server library 408 to execute the request and provide a response.

In more detail, the client 402 is the eniZone AJAX client running in a standard web browser and the application server is an HTTP server that presents a Java servlet interface 404 to the eniZone library 408. The method steps followed by the system are as follows:

1. The user clicks on a hyperlink in their web browser to watch a Zone. The eniZone AJAX client 402 makes a watch Zone call 400 to the eniZone servlet 404 running on the HTTP server (not shown).
2. The eniZone servlet 404 processes the client request by in turn requesting the Zone information 406 by a call to the eniZone library 408.
3. The eniZone library retrieves the Zone information 410 from the database (DB) 412.
4. The Zone information is returned 414 to the eniZone library 408 as rows of data from tables in the database 412.
5. The Zone information is returned 416 to the eniZone servlet 404 as XML.
6. The Zone information is returned 418 to the eniZone AJAX client 402 which then presents the Zone to the user.
7. The Zone information includes a URL for the Zone media. The eniZone AJAX client 402 selects an appropriate media player plug-in based on the media type, and passes the media URL to the media player plug-in. The media player plug-in then retrieves the media from the media server via this URL (420). The media server could be either a media server internal to the eniZone system or an external server.
8. The Zone media is returned to the media player plug-in running in the web browser 422. The media continues to play in the media player plug-in subject to control of the eniZone AJAX client and/or the user.
9. As the media is playing, the eniZone AJAX client makes a get Zone annotations call 424 to the eniZone servlet 404. The call requests annotations for a specified block of time within the timeline of the Zone.
10. The eniZone servlet processes the client request by in turn requesting 426 the block of Zone annotations by a call to the eniZone library 408.
11. The eniZone library retrieves 428 the annotation information from the database 412.
12. The annotation information is returned 430 to the eniZone library as rows of data from tables in the database 412.
13. The annotation information is returned 432 to the eniZone servlet 404 as XML.
14. The annotation information is returned 434 to the eniZone AJAX client 402 which then presents the annotations to the user.

Steps 9 to 14 are repeated for the duration of the Zone timeline while the Zone media is playing. It will also be understood that a single Zone may utilise multiple timelines. That is, a separate time line may be utilised for each additional media element displayed. In this manner, each timeline can operate independently of each other timeline.

As required, other client platforms can be supported by using alternate client and/or application server technologies. For example, instead of directly using the eniZone servlet, the application server could present a SOAP/WSDL interface to the eniZone library.

An alternative client application utilizing the SOAP/WSDL interface (e.g. a Java based application for mobile phone applications) would be used to deliver information to the user from the database and media server. Although the interface presented by the application server has changed and the client applications are different, the eniZone server library remains the same for both application servers.

Functional Specification—the eniZone Library and Widgets

The eniZone library (depicted in FIG. 4 as block 408) provides the functionality for storing and retrieving information in the eniZone system that is then used by the client to create the eniZone experience for the user. An example of the calls available in the eniZone library are shown in Appendices A and B respectively. Appendix A outlines a set of ‘core’ calls that are used to query the eniZone library. Appendix B outlines a set of ‘core’ calls that are used to construct ‘widgets’, which are small sections of HTML code which may be embedded into conventional HTML web pages. The ‘widgets’ allow for the functionality of eniZone to be incorporated into existing websites, such as MySpace, or a user's personal website.

An end user does not need to be aware of the technology that underlies the eniZone library, as the user interacts with the eniZone library through a conventional web browser. For example, a user may load an eniZone page by simply typing an appropriate URL into their browser. For example, to load a Zone with Zone id of 12, the user would type:

http://www.eniZone.com/WatchZone.php?c=12

Moreover, an end user creating a ‘Zone’ need not have any formal knowledge of programming or of the underlying technology of eniZone. An end user may simply access their eniZone site through a conventional web browser, which will guide them through the creation of an eniZone page.

The creation of an eniZone page is the subject of the co-pending patent application entitled “A graphical user interface”.

### Advantages

As may be seen from the previous description, a system and method in accordance with the described embodiment (and the broader invention defined by the claims of the present application) are preferably designed to streamline and simplify the process of aggregating disparate content temporarily so that multiple content may be provided to a user in an intuitive and coordinated manner.

Utilising the present invention, an Internet site may allow an end user to meaningfully interact with time based media, such as video clips and audio files, and receive related and useful information in real time.

Moreover, the described embodiment allows a user to meaningfully interact without the need to utilise proprietary languages, players, or other specialised software. The embodiment disclosed utilises a standard web browser to deliver content, and does so by using recognised Internet protocols and languages.

Although not required, the embodiments described with reference to FIGS. 3 and 4 can be implemented via an application programming interface (API), for use by a developer, and can be included within another software application, such as a terminal or personal computer operating system or a portable computing device operating system. Generally, as program modules include routines, programs, objects, components, and data files that perform or assist in the performance of particular functions, it will be understood that the functionality of the software application may be distributed across a number of routines, objects and components to achieve the same functionality as the embodiment and the broader invention claimed herein. Such variations and modifications would be within the purview of those skilled in the art.

### APPENDIX A

The eniZone library functionality is outlined herein by reference to the interface presented to the eniZone application servers.
In the function descriptions below the function name and parameters are presented in the following format:
function (param1, param2)
   Unless otherwise stated the parameters are of the string data type. The function name and parameters described are those provided by the eniZone library. The interface to the eniZone library presented to a client (e.g. the eniZone AJAX client) will be dependent on the application server. For example, with the eniZone servlet the client formulates a URL to invoke the servlet with the library request and parameter values included in the query string.
   For each of the functions described the response is a string representing the XML response to the request.

### Get Library Version

getVersion
Gets the version of the library.
Returns a string describing the version of the library.

### Example Response

```
<eniZone>
  <ServerResponse seqNo=“1”>
    <Version>eniZone server library
1.0.0 [20070226100924].
Copyright (c) enikos pty ltd 2006-2007. All rights
reserved.</Version>
  </ServerResponse>
</eniZone>
```

### Verify User Password

verifyPassword (userId, pw)
Verifies the given user id and password for the user id. Returns OK if given user id and password is verified ok, or error if not.

### Example Response 1

### Verification Failed

```
<eniZone>
  <ServerResponse seqNo=“2”>
    <Error>
      <Message>Invalid user or password</Message>
    </Error>
  </ServerResponse>
</eniZone>
```

### Example Response 2

### Verification ok

<eniZone>

<ServerResponse seqNo=“3”>

<UserInfo userID=“demo@enikos.com”>

<Nickname>enidemo</Nickname>
<LastLogin>2006-12-14T13:43:37.0+11:00</LastLogin>
<Prefs>

<AutoLinks>true</AutoLinks>

</Prefs>

</UserInfo>

</ServerResponse>

</eniZone>

### Verify User Login

verifyLogin(userId, pw)
Verifies the given user id and password for the user id. If verified updates the last login time for the user. Returns OK and the user preference if given user id and password is verified ok, or error if not.
The responses to this function are the same as for the responses to verifyPassword, the functionality differing in that this function also updates the users last login time.

### Get Available Zones

getAvailableZones(userId, maxZones, offset)
Gets list of Zones available to a user, sorted by Zone title.
If user id is not specified returns all available Zones subject to the max Zones and offset parameters.
If max Zones is specified the number of Zones returned will be equal to or less than max Zones.
If offset is specified then the first Zone in the list will be the Zone that is at position as specified by the offset in the list of all Zones available.
Returns list of Zone summary information. Such information would be suitable, for example, for presenting to a user to allow them to choose a Zone to experience.

### Example Response

```
<eniZone>
  <ServerResponse seqNo=“6”>
    <Channels>
      <Channel name=“Babes in Toyland” serviceID=“1”
mimeTypes=“video/x-ms-wmv”
thumbnailURI=“http://media.enizine.com/thumbnails/babesintoyland.jpg”
        >MGM Babes in Toyland (1934) based on Operatta by
Victor Herbert</Channel>
      <Channel name=“Blues Guitar Lesson - Track 4 Lesson
3 - Blues Note Riffs”
        serviceID=“181” mimeTypes=“video/x-ms-wmv”
thumbnailURI=“http://www.freeguitarvideos.com/Images/electric
guitarbig.jpg”
        >Learn standard riffs using the blues scale with
Peter Vogl</Channel>
      <Channel name=“Lord of the Rings (III)”
serviceID=“184”
        mimeTypes=“video/x-ms-wmv”
thumbnailURI=“http://media.enizine.com/thumbnails/20072001
_sd_lotr.jpg”/>
      <Channel name=“Ok Don&apos;t Go” serviceID=“185”
mimeTypes=“text/html”
thumbnailURI=“http://media.enizine.com/thumbnails/70.png”>
Nobody's
        watching Ok Go</Channel>
      <Channel name=“OK GO” serviceID=“115”
mimeTypes=“video/x-flv”
        thumbnailURI=“http://sjl-
static8.sjl.youtube.com/vi/NINJQ5LRh-0/2.jpg”
        >OK GO on those treadmills. </Channel>
      <Channel name=“Shuttle Launch” serviceID=“7”
mimeTypes=“video/x-ms-asf”
thumbnailURI=“http://media.enizine.com/thumbnails/shuttlelaunch
.jpg”
        >Discovery Launch July 4th 06</Channel>
    </Channels>
  </ServerResponse>
</eniZone>
```

### Get Zone id by Title

getZoneIdByTitle(title)
Checks if a Zone with the given title exists.
Returns OK with Zone id if such a Zone exists, or error response if no such Zone exists.

### Example Response 1

### No Zone with Title Found

```
<eniZone>
  <ServerResponse seqNo=“7”>
    <Error>NOT_FOUND</Error>
  </ServerResponse>
</eniZone>
```

### Example Response 2

### Zone with Title Found

<eniZone>

<ServerResponse seqNo=“8”>

<OK>

<ChannelID>1</ChannelID>

</OK>

</ServerResponse>

</eniZone>

### Get Zone for User Experience

getZoneForUserExperience(ZoneId, userId)
Gets the information for the Zone identified by the given Zone id.
Statistics for the Zone and for the identified user, if any, are also updated.
Returns the Zone information that enables the Zone experience to be loaded and started by the client.

### Example Response

```
<eniZone>
  <ServerResponse seqNo=“9”>
    <ChannelInfo channelID=“1”
authorID=“gerrard@enikos.com”
      defaultLink=“http://www.mgm.com/”>
      <Title>Babes in Toyland</Title>
      <Description>MGM Babes in Toyland (1934) based on
Operatta by Victor
        Herbert</Description>
      <VideoContent
location=“http://www.sabucattrailers.com/sabucat/babesintoyland
384.wmv”
        mimeType=“video/x-ms-wmv”/>
    </ChannelInfo>
  </ServerResponse>
</eniZone>
```

### Get Zone Chapter for User Experience

getChapterForUserExperience (chapterId, userId)
Gets the information for the Zone chapter identified by the given chapter id.
Statistics for the chapter and for the identified user, if any, are also updated.
Returns the chapter information that enables the chapter experience to be loaded and started by the client.
The response to this function is the same as for getZoneForUserExperience except that the information will pertain to the chapter.

### Get Temporal Material

getTemporalMaterial(ZoneOrChapterId, mode, start, end, includeAnnotations, includeObjects)
Gets material that is temporally associated with the Zone or chapter identified.
Mode must be block which is currently the only mode supported.
If mode is block, then start and end specify a block of time on the Zone or chapter timeline for which the temporally associated material within that block (inclusive of the specified start and end times) is to be returned. The start and end parameters are integer values specified in seconds.
If include annotations is true then annotations are included, otherwise they are excluded.
If include objects is true then objects (for overlays on the video) are included, otherwise they are exclucedexcluded.
Returns the list of information about temporally associated material as per the parameters (e.g. within the specified block of time along the Zone or chapter timeline).
Note: The associated material can include annotations, overlay objects, advertising information, etc.

### Example Response

```
<eniZone>
  <ServerResponse>
    <TimedXML>
      <TimedAuthorXML>
        <Annotation userID=“gerrard@enikos.com”
eventID=“1” annotationID=“1”>
          <Time>16</Time>
          <Duration>5</Duration>
<AutoLink>http://www.imdb.com/title/tt0024852/</AutoLink>
          <Text>
            <b>Movie info: </b>
            <a
href=“http://www.imdb.com/title/tt0024852/”>IMDb</a>
          </Text>
        </Annotation>
      </TimedAuthorXML>
      <TimedUserXML>
        <Annotation userID=“demo@enikos.com” eventID=“1”
annotationID=“123”>
          <Time>5</Time>
          <Text>This eniZone ‘thingo’ is way cool
man!</Text>
        </Annotation>
      </TimedUserXML>
    </TimedXML>
  </ServerResponse>
</eniZone>
```

### Add Annotation

addAnnotation(ZoneOrChapterId, userId, timePoint, duration, content, autoLink)
Adds a temporally associated annotation to the Zone or chapter identified by the given Zone or chapter id as authored by the identified user.
The time point specifies the time in seconds along the Zone or chapter timeline and is required.
The duration is optional and if provided specifies the number of seconds for which the annotation is considered to be active.
The content is required and contains the annotation content as XHTML that is suitable for placing within the content of a HTML body element.
The auto link is optional and if provided specifies a URL locating a resource intended to be automatically loaded in to the eniZone web page widget, if available, when the annotation is activated.
Returns OK with the created annotation information including the assigned annotation id if the annotation is added ok, otherwise returns an error response.

### Example Response

```
<eniZone>
  <ServerResponse>
    <Annotation userID=“demo@enikos.com” eventID=“1”
annotationID=“1234”>
      <Time>1</Time>
<AutoLink>http://www.wayoutwest.org/toyland/</AutoLink>
      <Text>
        <p>This is a classic Laurel &amp Hardy movie!</p>
      </Text>
    </Annotation>
  </ServerResponse>
</eniZone>
```

### Update Annotation

updateAnnotation(annotationId, ZoneOrChapterId, userId, timePoint, duration, content, autoLink)
Updates an existing annotation as identified by the given annotation id. The Zone or chapter id and user id must match those provided when the annotation was added by a call to the addAnnotation function.
The time point, duration, content and auto link parameters are optional. If they are provided then the values in the DB are updated, otherwise they are left unchanged.
Returns OK updated annotation information if the annotation is updated ok, otherwise returns an error response.
The response to this function is the same as for addAnnotation (the returned annotation information shall contain the modified annotation information).

### Delete Annotation

deleteAnnotation(annotationId, ZoneOrChapterId, userId)
Deletes an existing annotation as identified by the given annotation id. The Zone or chapter id and user id must match those provided when the annotation was added by a call to the addAnnotation function.
Returns OK if the annotation is deleted ok, otherwise returns an error response.

### Example Response

```
<eniZone>
  <ServerResponse>
    <OK/>
  </ServerResponse>
</eniZone>
```

### Add Zone

addZone(userId, title, mediaUrl, description, initialUrl, thumbnailUrl, groupId, categoryId, tags)
Adds a Zone as authored by the identified user.
The title is required and specifies the title for the Zone being added.
The media URL is required and locates the primary media for the Zone.
The description is optional and specifies a short textual description of the Zone.
The initial URL is optional and locates a resource intended to be automatically loaded in to the eniZone web page widget when the Zone is initially loaded.
The thumbnail URL is optional and locates a resource intended to be used, for example, as a thumbnail visual representation of the Zone in a list of Zones.
The group id is optional and specifies the id of the group with which the Zone is associated.
The category id is required and specifies the id of the category in to which the user is associating the Zone.
The tags are optional and specifies a string being a space separated list of tags being associated with the Zone.
Returns OK with the Zone id if added ok, otherwise returns an error response.

### Example Response 1

### Zone Added ok

```
<eniZone>
  <ServerResponse>
    <OK>
      <ChannelID>12</ChannelID>
    </OK>
  </ServerResponse>
</eniZone>
```

### Example Response 2

### Error Response

### Zone with Title Already Exists

<eniZone>

<ServerResponse>

<Error>Add channel failed: channel 12 already exists

with title

‘Demonstration Zone’</Error>

</ServerResponse>

</eniZone>

### Update Zone

updateZone(ZoneId, userId, title, mediaUrl, description, initialUrl, thumbnailUrl, groupId, categoryId, tags)
Updates an existing Zone as identified by the given Zone id. The user id must match that provided when the Zone was added by a call to the addZone function.
The title, media URL, description, initial URL, thumbnail URL, group id, category id and tags parameters are optional. If they are provided then the values in the DB are updated, otherwise they are left unchanged.
Returns OK if the annotation is updated ok, otherwise returns an error response.

### Example Response

```
<eniZone>
  <ServerResponse>
    <OK/>
  </ServerResponse>
</eniZone>
```

### Delete Zone

deleteZone(ZoneId, userId)
Deletes an existing Zone as identified by the given Zone id. The user id must match that provided when the Zone was added by a call to the addZone function.
Returns OK if the Zone is deleted ok, otherwise returns an error response.

### Example Response 1

### Ok

```
<eniZone>
  <ServerResponse>
    <OK/>
  </ServerResponse>
</eniZone>
```

### Example Response 1

### Error

### Not Zone Owner

<eniZone>

<ServerResponse>

<Error>Delete channel failed: not channel

owner</Error>

</ServerResponse>

</eniZone>

### Get Zone User Vote

getZoneUserVote(ZoneId, userId)
Gets the vote made by the identified user for the identified Zone.
Returns the user vote for the Zone as a decimal number in the range 0-5 if such a vote exists, or an error response otherwise.

### Example Response

```
<eniZone>
  <ServerResponse>
    <ChannelUserVote eventID=“1” userID=“demo@enikos.com”
vote=“4.0”/>
  </ServerResponse>
</eniZone>
```

### Add Zone User Vote

addZoneUserVote(ZoneId, userId, vote)
Adds or updates a vote made by the identified user for the identified Zone.
The vote is specified as a decimal number in the range 0-5. Any existing vote by the user for the Zone is replaced by the new vote.
The total vote statistics for the Zone are also accumulated. Previous votes by the user for the Zone remain included in the Zone accumulated vote statistics.
Returns OK if the user vote is added ok, otherwise returns an error response.

### Example Response

```
<eniZone>
  <ServerResponse>
    <OK/>
  </ServerResponse>
</eniZone>
```

### Get Upload id

getUploadId(userId, fileSize)
Gets a unique id for uploading a user file to the eniZone system.
Returns an id for an uploaded file.

### Example Response

```
<eniZone>
  <ServerResponse>
    <OK>
      <FileUploadID>77</FileUploadID>
    </OK>
  </ServerResponse>
</eniZone>
```

### Add Group

addGroup (userId, name, description, moderatedMembership, moderatedZones, thumbnailUrl, joinSelf)
Adds a group owned by the identified user.
The name is required and specifies the name of the groupo. The description is optional and specifies textual description of the group.
The moderated membership is an optional boolean flag and if true indicates membership in the group is moderated, otherwise membership is not moderated (the default).
The moderated Zones is an optional boolean flag and if true indicates that Zones added to the group are moderated, otherwise Zones added to the community are not moderated (the default).
The icon URL is optional and locates a thumbnail image that can be used as a visual representation of the group.
The join self is an optional boolean flag and if true the user identified by the user id is added as a group member.
Returns OK with group id if the group is added ok, or an error response otherwise.

### Example Response

```
<eniZone>
  <ServerResponse>
    <OK>
      <GroupID>123</GroupID>
    </OK>
  </ServerResponse>
</eniZone>
```

### Add Group Member

addGroupMember(groupId, userId)
Adds the identified user to the identified group.
Returns OK if user added to group ok, otherwise returns an error response.

### Example Response

```
<eniZone>
  <ServerResponse>
    <OK/>
  </ServerResponse>
</eniZone>
```

### Add User

addUser(userId, password, firstName, lastName, dateOfBirth, nickname, gender, address1, address2, address3, city, state, country, postcode, telephone, fax, webHomePage)
Adds a user who will be identified by the given user id.
The user id must be a valid email address.
The password is required and specifies the password required to verify the user.
The first name is required and specifies the first name of the user.
The last name is optional and specifies the last name of the user.
The date of birth is required and specifies the date of birth of the user in the format YYYYMMDD where YYYY is the four digit year of birth, MM is the two digit month of birth where January is represented by 01 through to December represented by 12, and DD is the two digit day of the month.
The nickname is required and specifies the nickname by which the user will be publicly known on the eniZone web site.
The gender is optional and specifies the gender of the user and if provided must have a value of either M for male or F for female.
The address 1, address 2, address 3, city, state, country, and postcode are optional and if provided combine to form the complete street or postal addressing information for the user.
The telephone and fax are optional and specify the telephone number and fax number of the user.
The web home page is optional and specifies a URL locating the home web page of the user.
Returns OK if the user is added ok, otherwise returns an error response.

### Example Response

```
<eniZone>
  <ServerResponse>
    <OK>Registration is successful</OK>
  </ServerResponse>
</eniZone>
```

### Update User Preferences

updateUserPreferences(userId, autoLinksOn)
Updates the preferences information for the user identified by the given user id. The user id must match that provided when the user was added by a call to the addUser function.
The auto links on is optional and is a Boolean flag specifying whether auto links are loaded automatically when experiencing a Zone or not. If provided the preference value is updated otherwise it is left unchanged.
Returns OK if the user is added ok, otherwise returns an error response.

### Example Response

```
<eniZone>
  <ServerResponse>
    <OK/>
  </ServerResponse>
</eniZone>
```

### Update User Address

updateUserAddress(userId, address1, address2, address3, city, state, country, postcode, telephone, fax)
Updates the address details for the user identified by the given user id. The user id must match that provided when the user was added by a call to the addUser function. TBDThe address 1, address 2, address 3, city, state, country, postcode, telephone, and fax are optional. If they are provided then the values in the DB are updated, otherwise the are left unchanged.
Returns OK if the user address details are updated ok, otherwise returns an error response.

### Example Response

```
<eniZone>
  <ServerResponse>
    <OK/>
  </ServerResponse>
</eniZone>
```

### Update User Personal Details

updatePersonal(userId, firstName, lastName, dateOfBirth, nickname, gender, webHomePage)
Updates the personal details for the user identified by the given user id. The user id must match that provided when the user was added by a call to the addUser function. TBDThe first name, last name, date of birth, nickname, gender and web home page are optional. If they are provided then the values in the DB are updated, otherwise they are left unchanged.
Returns OK if the user personal details are updated ok, otherwise returns an error response.

### Example Response

```
<eniZone>
  <ServerResponse>
    <OK/>
  </ServerResponse>
</eniZone>
```

### Update User Account Details

updateAccount(userId, password)
Updates the account details for the user identified by the given user id. The user id must match that provided when the user was added by a call to the addUser function.
TBDThe password is required and specifies the new password which must be different to the existing password.
Returns OK if the user account details are updated ok, otherwise returns an error response.

### Example Response

```
<eniZone>
  <ServerResponse>
    <OK/>
  </ServerResponse>
</eniZone>
```

### Get User Information

getUserInformation(userID)
Gets the information related to the user identified by the given user id.
Returns the user information if retrieved ok, otherwise returns an error response.

### Example Response

```
<eniZone>
  <ServerResponse>
    <UserInfo>
      <Email>demo@enikos.com</Email>
      <Password>foo</Password>
      <FirstName>demo</FirstName>
      <LastName/>
      <Nickname>enidemo</Nickname>
      <DoB>01/01/1972</DoB>
      <Gender/>
      <Address1/>
      <Address2/>
      <SuburbAndCity/>
      <State/>
      <Country/>
      <Postcode/>
      <Phone/>
      <Fax>12345678</Fax>
      <WebHomePage>http://www.enikos.com/</WebHomePage>
    </UserInfo>
  </ServerResponse>
</eniZone>
```

### Get URL Information

getURLInfo(url)
Gets information about the given URL, if possible, including MIME type.
Returns the URL information if it can be retrieved, or an error response otherwise.

### Example Response 1

### Information about a HTML Web Page

```
<eniZone>
  <ServerResponse>
    <URLInfo url=“http://www.foobar.com/”>
      <HttpInfo Status-Code=“200” Reason-Phrase=“OK”
mimeType=“text/html”>
        <Headers>
          <Content-Type>text/html; charset=UTF-8</Content-
Type>
        </Headers>
      </HttpInfo>
    </URLInfo>
  </ServerResponse>
</eniZone>
```

### Example Response 2

### Information about a GIF Image

```
<eniZone>
  <ServerResponse>
    <URLInfo url=“http://www.foobar.com/images/logo.gif”
      mimeType=“image/gif”>
      <HttpInfo Status-Code=“200” Reason-Phrase=“OK”
mimeType=“image/gif”>
        <Headers>
          <Content-Length>2776</Content-Length>
          <Content-Type>image/gif</Content-Type>
        </Headers>
      </HttpInfo>
    </URLInfo>
  </ServerResponse>
</eniZone>
```

### Example Response 3

### Information about a WMV Video

```
<eniZone>
  <ServerResponse>
    <URLInfo url=“http://www.foobar.com/mymovie.wmv”
      mimeType=“video/x-ms-wmv”>
      <HttpInfo Status-Code=“200” Reason-Phrase=“OK”
mimeType=“video/x-ms-wmv”>
        <Headers>
          <Content-Length>9335353</Content-Length>
          <Content-Type>video/x-ms-wmv</Content-Type>
        </Headers>
      </HttpInfo>
    </URLInfo>
  </ServerResponse>
</eniZone>
```

### Example Response 4

### Error

```
<eniZone>
  <ServerResponse>
    <URLInfo url=“http://www.thisdoesnotexixt.com/”>
      <HttpInfo Status-Code=“502” Reason-Phrase=“Bad
Gateway”
        mimeType=“text/html”>
        <Headers>
          <Content-Length>329</Content-Length>
          <Content-Type>text/html</Content-Type>
        </Headers>
      </HttpInfo>
    </URLInfo>
  </ServerResponse>
</eniZone>
```

### APPENDIX B

### Widgets

### User Documentation for Zone Widgets

### General Information on Widgets

### EniZoneZoneWidget

Container to group all the eniZone widgets together—useful for eniZone widgets that require widget-to-widget interaction. Official eniZone widgets inside the container will automatically be registered to the Zone container's widget list.
Eventually, this will host the major timeline for the entire Zone, and be able to utilise a Zone Script file to be able to control two media, create presentations etc etc etc
If an EniZone widget is on the page, then it will automatically load the Zone based on the URL query string.
The query string uses the following values:

| Value | Description |
|---|---|
| c | Specifies the Zone ID to load |
| t | Specifies the beginning timestamp to begin |
| | playback (Optional). If no timestamp is present |
| | then Zone will begin at t = 0. |
| h | Specifies the ChapterID (if a chaptered Zone |
| | is selected) |

### Example

To load Zone with Zone id of 12:
http://www.eniZone.com/WatchZone.php?c=12

### Widget Parameters

servletURL
string
Defines the location to the servlet (i.e. /ajaxServlet/ajaxServlet or http://some.where.on.net/path/servletName)

### Events

onZoneLoad(errorMessage)
Specifies a user function which is called when the page has retrieved the Zone information from the AJAX server. At this point the media will begin playing.
   onFatalError(errorMessage)
Specifies the user function to be called when the Zone has encountered a fatal error.
   onError

### Functions

getContentURL( )
Returns the current URL as used by the media player (demanagled).
   getContentOriginURL( )
Returns the original (before demangling) URL as entered during Zone creation.
   getContentOriginLogo( )
Returns the URL to the logo if the video is sourced from another website (e.g., youtube, google, etc).
   getZoneName( )
Returns the Zone name as specified during Zone creation.
   getInitialWebURL( )
Returns the URL defined in the Zone for the Initial Webpage for display.

### Play( )

Plays the Zone.

### Stop( )

Stops the Zone.

### Pause( )

Pauses the Zone.

### Seek( )

getZoneDuration( )
Returns the duration of the Zone.
   getZoneCurrentTime( )
Returns the currentTime of the Zone.
   getZoneStatus( )
Returns the status of the Zone. I.e. Stopped, Playing, Paused . . . .

### Example

To load a Zone with the servletURL, load function and error and fatal error functions.

### Example

```
<script type=”text/javascript” language=”JavaScript”>
  function myZoneLoad( ){
      var myZone = dojo.widget.byId(‘main’);
      alert(“initial Web
URL=”+myZone.getInitialWebURL( );
  }
  function myError(message){
      alert (‘An Error has occurred:’+message);
  }
</script>
...
<div id=″main″ dojoType=″enikos:EniZoneZoneWidget″
    servletURL=″/ajaxServlet/ajaxServlet″
    onFatalError=″myError″ onError=″myError″
    onZoneLoad=″myZoneLoad″>
<!-- rest of Zone widgets and HTML goes here-->
</div>
```

### EniZoneMediaWidget

Holds the timeline for the media clip to be loaded. This is a generic widget which will select the player according to the mimeType as stored in the Zone info on the server.

### Widget Parameters

displayPlayerControls
boolean
Specifies if the controls are to be hidden (default: true).
   width
string
Specifies the width.
   height
string
Specifies the height.

### Events

onMediaStart
Optional
Called when the media is given a URL and begins playback.
   onMediaEnd
Optional
Called when the media clip has ended.

### Functions

mp_play( )
Plays the currently loaded clip. Resumes if previously paused.
   mp_stop( )
Stops the playback of the video.
   mp_pause( )
Pauses the playback of the video.
   mp_seek(newTime)
Seeks the media to the new timepoint. (Note: this currently does not behave correctly for playlist files, like ASX).
   mp_setVolume(volume)
Sets the volume of the mediaplayer.
   getMediaStatus( )
Returns the status of the media player (if available) as a string.
   getMediaTime( )
Returns the current time position of the media loaded. If the media loaded is playing a playlist, then this number is measured absolutely from the first clip.
   getMediaDuration( )
Returns the total duration of the media loaded. If the media loaded is a playlist, then this returns the total duration of the entire playlist. (in some cases, i.e., MS Media, this information is unavailable).

### Example 1

```
<div id=’myMedia’ dojoType=”enikos:EniZoneMediaWidget”
height=”200px” width=”300px”></div>
<input type=“text” id=“playTime”>
<script type=”text/javascript” language=”JavaScript”>
        var media = dojo.widget.byId(‘myMedia’);
        var timeBox = dojo.byId(‘playTime’)
        function getMediaPlayTime( ){
            var theTime= media.GetMediaTime( );
          timeBox.value = theTime;
            setTimeout (‘getMediaPlayTime( )’, 1000);
        }
        getMediaPlayTime( );
)
</script>
```

### Example 2

A user wants to call a function, when the media begins.

```
<script type=”text/javascript” language=”JavaScript”>
  function mediaStarting( )
  {
      // do something here
  }
</script>
...
<div dojoType=”enikos:EniZoneMediaWidget” height=”200px”
width=”300px” onMediaStart=”mediaStarting”></div>
EniZoneWebpageWidget
```

This widget is responsible for displaying linked webpages. Webpages will be displayed within an IFrame.

### Widget Parameters

width
string
Width of the webpage IFrame. Accepts the same values as the width style in CSS. (default: 100%)
   height
string
Height of the webpage IFrame. Accepts the same values as the height style in CSS. (default: 100%)
   url
string
Initial URL to display (optional)

### Events

ondisplayWebpage
Event which is called when a webage is displayed.

### Functions

displayWebPage(url)
Loads the specified url into the widget's IFrame
   getDisplayedURL( )
Returns the currently displayed URL in the widget.

### Example

A user wishes to popup an alert showing the URL of newly displayed webpages.

### Example

```
<script type=”text/javascript” language=“JavaScript”>
  function myDisplayFunc( ){
      var webWidget = dojo.widget.byId(‘myWeb’);
      alert(webWidget.getDisplayedURL( ));
  }
</script>
...
<div id=’myWeb’ dojoType=”EniZoneWebpageWidget”
width=”300px” height=”300px” url=”http://www.enikos.com”
ondisplayWebpage=”myDisplayFunc”></div>
...
```

### EniZoneAnnotationsWidget

This widget is the container used for displaying Annotations.

### Widget Parameters

userTab
boolean
Specifies if the user tab is to be displayed.
   authorTab
boolean
Specifies if the author tab is to be displayed.
   width
string
Accepts CSS definitions i.e., 100%, 120em, 200px etc. (default: 100%).
   height
string
Accepts CSS definitions i.e., 100%, 120em, 200px etc. (default: 100%).

### Functions

displayAuthorAnnotation(timestamp, htmlAnnotation, autolink)
Inserts the htmlAnnotation into the authors annotation pane, setting the displayed timestamp to the current Zone playtime.
   displayUserAnnotation(timestamp, htmlAnnotation, autolink)
Inserts the htmlAnnotation into the users annotation pane, setting the displayed timestamp to the current Zone playtime.
   setTime(theCurrentTime)

### Events

### EniZoneFlashOverlayWidget

setCurrentTime

1. A system for providing a presentation to a user comprising a framework arranged to provide a time based primary media element and at least one secondary media element to a user, wherein the at least one secondary media element is arranged to be presented to the user when a predetermined time is reached during presentation of the primary media element.

2. The system in accordance with claim 1, the framework including a retrieval module arranged to retrieve the primary media element and the at least one secondary media element, and temporarily associate the primary media element and the at least one secondary media element.

3. The system in accordance with claim 2, further including a client application arranged to display the primary media element and the at least one secondary media element in a unified interface.

4. The system in accordance with claim 3, wherein the client application includes the retrieval module.

5. The system in accordance with claim 4, further including a database arranged to hold information regarding the primary media element and the at least one secondary media element.

6. The system in accordance with claim 5, the retrieval module further including a timing module arranged to poll the database at predetermined time intervals, to determine whether further secondary media elements should be retrieved.

7. The system in accordance with claim 6, wherein the framework information includes information regarding the location of the primary media element and the at least one secondary media element.

8. The system in accordance with claim 7, wherein the framework information includes timing information.

9. The system in accordance with claim 8, wherein the database includes a locator arranged to allow the retrieval module to locate each one of the primary media-element and the at least one secondary media element.

10. The system in accordance with claim 9, wherein the timing information and the locator are linked.

11. The system in accordance with claim 10 when dependent on claim 5, wherein the timing module receives the timing information to determine whether a further at least one secondary media element should be displayed, and if so, utilises the linked locator information to retrieve the element.

12. The system in accordance with claim 8, wherein the timing module receives a plurality of discrete timing information sets, each timing information set operating independently of each other timing information set.

13. The system in accordance with claim 8, wherein the timing information set includes instructions to invoke a further timing information set.

14. The system in accordance with claim 13, wherein the locator directs the client application to a third party server containing one of the primary media element and the at least one secondary media element.

15. The system in accordance with claim 5, wherein the database is located remotely from the client application.

16. The system in accordance with claim 15, wherein the client application is a web browser, capable of interpreting HyperText Markup Language (HTML) and the JavaScript programming language.

17. The system in accordance with claim 16, wherein the web browser is capable of interpreting programming code written utilising Asynchronous Java and XML (AJAX) techniques.

18. The system in accordance with claim 17, wherein the web browser includes a widget arranged to connect with the servlet application and receive the locator information.

19. The system in accordance with claim 1, wherein the primary media element is one of a video and audio file.

20. The system in accordance with claim 1, wherein the at least one secondary media element is any one of a video file, an audio file, a text file and a web page.

21. The system in accordance with claim 5, wherein the database contains information in a XML format.

22. The system in accordance with claim 21, wherein the XML format is compatible with a MPEG standard.

23. A method for providing a presentation to a user comprising the steps of providing a time based primary media element and at least one secondary media element to a user, whereby the at least one secondary media element is arranged to be presented to the user when a predetermined time is reached during presentation of the primary media element.

24. The method in accordance with claim 23, comprising the further step of retrieving the primary media element and the at least one secondary media element, and temporarily associating the primary media element and the at least one secondary media element.

25. The method in accordance with claim 24, comprising the further step of displaying the primary media element and the at least one secondary media element in a single interface.

26. The method in accordance with claim 25, comprising the further step of accessing information in a database, the information including information regarding the primary media element and the at least one secondary media element.

27. The method in accordance with claim 26, comprising the further step of polling the database at predetermined time intervals, to determine whether a further secondary media element should be retrieved.

28. The method in accordance with claim 27, whereby the information includes information regarding the location of the primary media element and the at least one secondary media element.

29. The method in accordance with claim 28, whereby the information includes timing information.

30. The method in accordance with claim 27, comprising the further step of the timing module receiving a plurality of discrete timing information sets, each timing information set operating independently of each other timing information set.

31. The method in accordance with claim 27, whereby the timing information set includes instructions to invoke a further timing information set.

32. The method in accordance with claim 31, whereby the database includes a locator arranged to allow location of each one of the primary media element and the at least one secondary media element.

33. The method in accordance with claim 32, whereby the timing information and the locator are linked.

34. The method in accordance with claim 33, whereby on determination that a further at least one secondary media element should be displayed, utilising the linked locator information to retrieve the secondary media element.

35. The method in accordance with claim 34, comprising the further step of retrieving one of the primary media element and the at least one secondary media element from a remote server.

36. The method in accordance with claim 29, whereby the database is located remotely from the client application.

37. The method in accordance with claim 36, whereby the unified interface is a web browser, capable of interpreting HyperText Markup Language (HTML) and the JavaScript programming language.

38. The method in accordance with claim 37, whereby the web browser is capable of interpreting programming code written utilising Asynchronous JavaScript and XML (AJAX) techniques.

39. The method in accordance with claim 26, whereby the primary media element is one of a video or audio file.

40. The method in accordance with claim 26, whereby the at least one secondary media element is any one of a video file, an audio file, a text file and a web page.

41. The method in accordance with claim 29, whereby the database contains information in a XML format.

42. The method in accordance with claim 41, wherein the XML information is compatible with a MPEG standard.

43. A computer program arranged to, when executed on a computing system, perform the steps in accordance with claim 23.

44. A computer readable medium incorporating a computer program in accordance with claim 43.
